(19) United States
(12) Patent Application Publication
(10) Pub. No.: US 2015/0292576 A1
(43) Pub. Date: Oct. 15, 2015

(54) DRY FRICTION CLUTCH WITH DAMPENING SYSTEM

(71) Applicant: BorgWarner Inc., Auburn Hills, MI (US)

(72) Inventors: Samuel E. Settineri, Marshall, MI (US); Jonathan B. Stagg, Bellevue, MI (US); Mark K. Oerther, Battle Creek, MI (US); Sanjeev S. Sholapurkar, Marshall, MI (US)

(21) Appl. No.: 14/675,779

(22) Filed: Apr. 1, 2015

Related U.S. Application Data
(60) Provisional application No. 61/978,839, filed on Apr. 12, 2014.

(51) Int. Cl. F16D 65/00; F01P 7/08; F16D 27/01; F16D 25/12

(52) U.S. Cl. CPC F16D 65/0018; F16D 25/12; F01P 7/084; F16D 27/01

(57) ABSTRACT

A pneumatic dry friction clutch with a cone-shaped friction backing member and an intermediate member interlinked together with mating protrusions and recesses. The axial and circumferential degrees of freedom minimize or reduce noise and vibrations of the clutch, particularly any resonance. The clutch can be either an On-Off clutch or a two-speed clutch.

### CROSS REFERENCE TO RELATED APPLICATIONS

This application claims the benefit of U.S. Provisional Application Ser. No. 61/978,839, filed Apr. 12, 2014, which is incorporated herein by reference.

### TECHNICAL FIELD

The present invention relates generally to dry friction clutches and more particularly to systems for dampening undesirable vibrations of dry friction clutches.

### BACKGROUND OF THE INVENTION

Vehicle engines commonly utilize cooling systems to remove excess heat from the engine and maintain an optimal operating temperature. The cooling system pumps a coolant through the engine and other components in order to control engine temperature. Heat generated within the engine and other components is absorbed by the coolant and dispersed into the surrounding atmosphere through the use of a radiator. In order to improve dispersal by the radiator, it is common to utilize fan assemblies to draw or force air past the radiator to assist in temperature transmission.

It is not always desirable for such fan assemblies to be run continuously. At times, it is desirable for the temperature within the coolant to increase rather than decrease. Additionally, continuous operation when unnecessary places a non-required draw on the engine and thereby reduces efficiency. To compensate for this, present fan assemblies utilize fan clutch assemblies that allow for the selective engagement of the fan to the engine such that the fans are engaged only when necessary. The fan clutch assemblies may be operated in a host of configurations including electromagnetic, hydraulic and air-pressure actuated. It is common for these systems to be biased towards fan operation such that when failure occurs in the clutch assembly, the fan continuously operates to keep the engine cool.

An issue with these clutch assemblies, particularly for fan clutch assemblies, relates to vibrations and noise. It is important to reduce the vibrations and associated noise with these assemblies so that they do not become unacceptable to the vehicle drivers and passengers. Unnecessary vibration can also lead to potentially dangerous structural loads on the assembly and its components. Too much vibration and noise can result in warranty claims and other unnecessary servicing.

Efforts have been made to reduce undesirable noise and vibrations from fan and other accessory drives and assemblies, but there are still many areas for improvement. In addition, new types and models of such assemblies often create their own new forms of noise and vibrations which need to be dampened and controlled.

It would, therefore, be highly desirable to reduce and minimize noise and vibrations of clutch assemblies, particularly those used for accessory drives, such as fan drives. This desire applies for all types of drive assemblies, particularly for dry friction fan drive assemblies.

### SUMMARY OF THE INVENTION

It is therefore an object of the invention to provide methods, assemblies and systems for reducing and/or minimizing noise and vibrations for clutch drive assemblies, particularly, for example, for dry friction fan clutch drive assemblies. The present invention is directed to satisfying that object.

A preferred form of the invention can be utilized with pneumatic dry friction fan clutch assemblies, such as those disclosed in U.S. Pat. Nos. 7,137,362 and 7,731,006. In these assemblies, a central piston chamber is positioned therein and feeds a pressure chamber. A translatable clutch piston is in communication with the pressure chamber and is movable between disengaged and activated positions in response to air pressure fed into the pressure chamber. A rotating input drive member is provided along with a clutch housing. A cone clutch element translates between a clutch engaged position against a friction member to a clutch disengaged position in response to the clutch piston moving between the two positions. The cone clutch element engages the rotating drive shaft when in the clutch engaged position. A clutch spring biases the cone clutch element towards the clutch engaged position with a clutch engagement force.

In accordance with preferred forms of the invention, a two-piece structural assembly is used to position and hold the friction material in place. The assembly includes an intermediate member and a cone-shaped backing member. The two members are linked and joined together with an interlinking plurality of protrusions and recesses, such as splines and notches, which allow limited freedom of movement between the two members and acts to dampen vibrations, such as friction-induced resonance.

This embodiment can be used with either an ON-OFF fan drive or a drive which also includes an eddy-current clutch arrangement. For the latter fan drive, magnets can be installed on the intermediate member, and a flux ring can be included on the assembly.

Other objects, benefits and features of the present invention will become apparent when viewed in light of the detailed description and preferred embodiments when taken in conjunction with the attached drawings and claims.

### BRIEF DESCRIPTION OF THE DRAWINGS

FIG. 1 depicts a prior art cone clutch fan drive assembly.

FIG. 2 depicts a cone clutch fan drive in accordance with a first embodiment of the invention.

FIG. 3 is an exploded view of the fan drive depicted in FIG. 2.

FIG. 4 is an enlarged view depicting the linking of an intermediate member and a cone-shaped backing member.

FIGS. 5 and 6 illustrate alternate embodiments of cone-shaped backing members which can be utilized with the invention.

FIGS. 7A and 7B illustrate another alternate embodiment of a cone-shaped backing member which can be utilized with the invention.

FIG. 8 illustrates an embodiment of the invention for use in a two-speed clutch assembly.

FIG. 9 is an exploded view of the fan drive depicted in FIG. 8.

FIG. 10 illustrates a prior art two-speed fan drive.

FIG. 11 illustrates another alternate embodiment of the invention.

### DESCRIPTION OF PREFERRED EMBODIMENTS

The present invention provides methods, assemblies, and systems for reducing or minimizing noise and vibrations from a friction clutch assembly. The invention has particular use for dry friction clutch assemblies for rotating cooling fans in vehicles, but it can be used with any type of clutch and any type of friction drive for any accessory.

For purposes of describing the present invention in more detail, it will be described herein with respect to its use in a pneumatically driven dry friction clutch for a cooling fan. This is not to be taken, however, as limiting the present invention. This is only one embodiment and use of the invention. The invention should not be limited to use only with this type of clutch assembly and for this purpose.

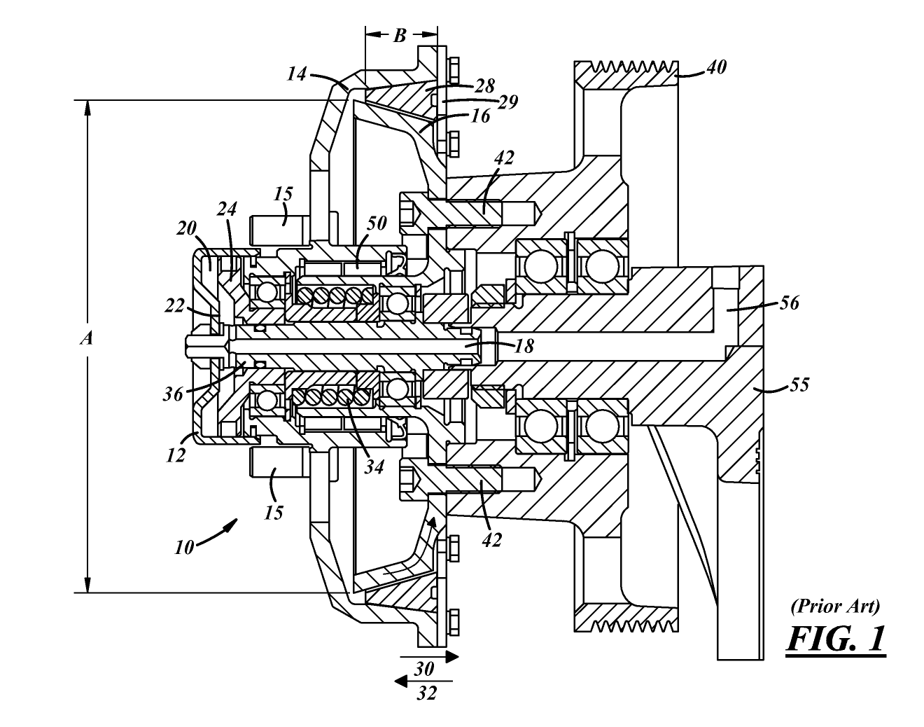

FIG. 1 depicts a cone clutch fan drive assembly 10 of a type known in the industry. The fan drive assembly 10 includes a clutch assembly 12 having a clutch housing 14. The present invention provides novel and valuable improvements to such clutch assemblies that minimizes and reduces noise and vibration of the assembly during use.

The components and operation of the clutch assembly 12 are similar to the clutch assemblies shown and described in U.S. Pat. Nos. 7,137,362 and 7,731,006. Thus, many of the components contained in the clutch assembly utilized herewith, as well as the basic operation thereof, do not need to be discussed in detail and reference is made to these two patents for a further discussion and description of them.

In general, the clutch actuating assembly 12 includes a central piston chamber 18 positioned within the chamber cap 22. Preferably positioned along the centerline of the drive assembly 10, the central piston chamber 18 provides a pathway through the clutch actuating assembly 12 through which pressurized air may be selectively passed. The pressurized air passes through the central piston chamber 18 and into a pressure chamber 20 formed between the chamber cap 22 and a translatable clutch piston 24. The translatable clutch piston 24, is in operable communication with a cone-shaped clutch friction member 28. The friction member typically has an annular wedge shape and is securely affixed to the housing member 14. When air pressure is supplied, the pressure chamber 20 becomes pressurized and the translatable clutch piston 24 is moved in the direction of arrow 30 into a clutch disengaged position. When in its disengaged position, the cone clutch friction member 28 disengages from the rotating input member 16 such that the input member 16 rotates independently from the cone clutch friction member 28.

The cone clutch friction member 28 travels axially only a small distance between the engaged and disengaged positions. In operation, the travel of the cone clutch friction member can be on the order of 0.05-0.15 inches.

A clutch spring 34 is positioned within the clutch housing 14 and biases the cone clutch friction member 28 towards a clutch engaged position (see arrow 32 in FIG. 1). When pressure within the pressure chamber 20 is released, the clutch spring 34 moves the cone clutch friction member 28 into the clutch engaged position and the translatable clutch piston 24 moves into the piston neutral position. The clutch spring 34 also provides a maximum spring force which in turn translates into a clutch engagement force between the cone clutch friction member 28 and the rotating input member 16. This force prevents slippage between the member 28 and the input member 16.

A needle bearing member 50 is positioned in between the rotating input member 16 and the cone clutch friction member 28. The needle bearing member 50 depicted is a dual needle bearing member.

In conventional air actuated cone clutches, such as the one shown in FIG. 1, a solid ring of friction material having a tapered or frustoconical annular shape is positioned on the friction member 28. The friction member can be a continuous 360° piece of friction material, or segmented into numerous pieces or sections, which is/are attached to the wedge shaped member 28. The friction material can be made of any conventional friction liner material. The friction member 28 can be held in place against the inner surface of the outer drum housing member 14. The friction member can also be allowed to float against retainer plate 29, or be secured in any conventional manner.

As an alternate embodiment, it is also possible to mount or attach the friction member or friction liner to the radially outer surface of the input drive member 16.

The housing 14 is the output member of the fan assembly 10 and has a fan member or the like (not shown) attached to its front axial end (the left end in FIG. 1). The fan is attached to the housing by a series of bolts 15. The input drive member 16 is directly connected to the input pulley member 40. A plurality of bolts 42 or the like attach the pulley member 40 to the input member 16. The pulley member is attached to an engine belt (not shown) which is driven by the engine essentially at, or close to, the engine RPM speed (also called the “input speed”).

An actual known fan assembly of the type shown in FIG. 1 is a Model K-30 clutch assembly made and sold by BorgWarner Inc., Auburn Hills, Michigan. The dimensions of a popular K-30 model include: a radially outer housing 14 diameter of 200.8 mm (7.9 inches), a friction interface major diameter (FIMD) “A” of 164.25 mm (6.47 inches), and an axial length “B” of the cone-shaped friction member 28 of 24.4 mm (0.96 inches).

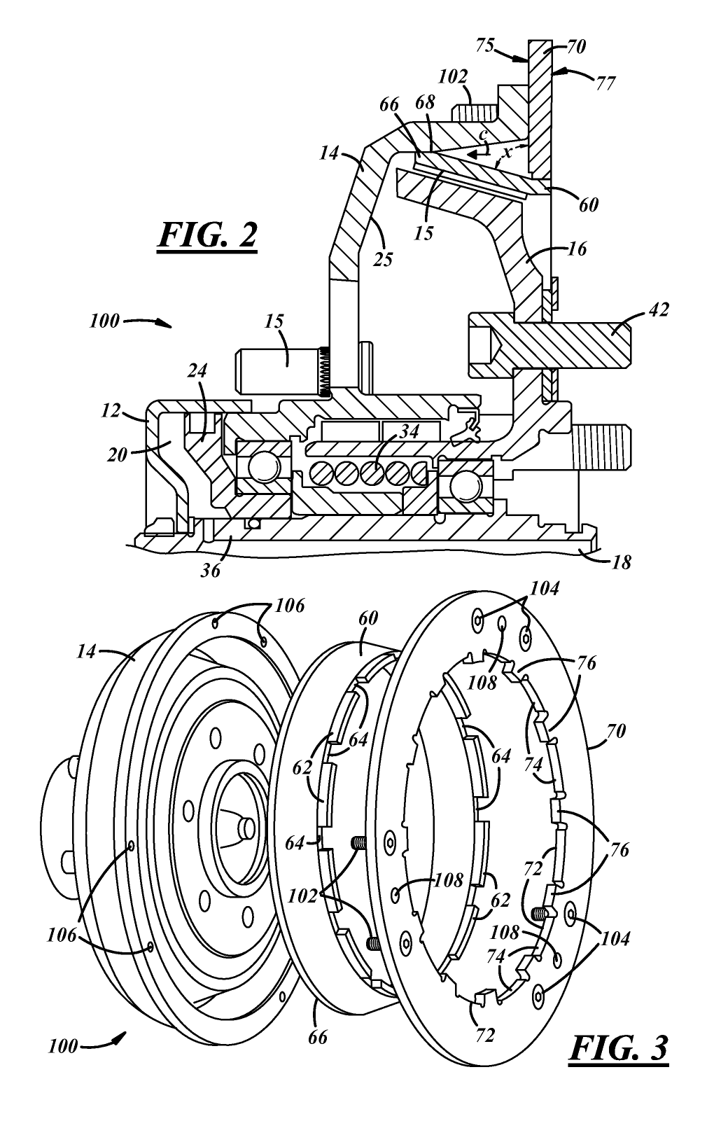

FIGS. 2-4 disclose a preferred embodiment of the invention. The components of the clutch assembly which are the same as those shown in FIG. 1 are referred to by the same reference numbers. In all the Figures, as exemplified in FIG. 1, the fan assemblies and pulley are typically attached to a mounting member 55 which is securely mounted to a vehicle in a conventional manner. Pneumatic pressure used to operate the fan assembly is supplied to the assemblies through passageways 56 in the mounting member 55.

FIG. 2 only shows one-half of a cross-section of the assembly. The other one-half is a mirror image of what is shown, and this is a common way of showing cross-sections of dry friction drive clutches.

In FIG. 3, the full housing 14 is shown in a perspective view. In FIGS. 2 and 3, the invention includes a cone shaped backing member 60 and an annular intermediate member 70. The entire friction clutch assembly is referred to by the reference number 100.

The cone shaped backing member 60, also called a “cone piece”, has the shape shown in FIG. 3 and is mounted and installed in the assembly 100 in the manner shown in FIG. 2. The intermediate member 70 is connected to the housing 14 and holds the cone piece in place. For this purpose, a plurality of fasteners 102, such as bolts, are positioned through openings 104 in the intermediate member 70 and threadedly installed in threaded holes 106 in the housing 14. In this regard, although six openings 104, six fasteners 102 and six threaded holes 106 are shown, it is understood that any number of each can be used so long as the intermediate member 70 is securely connected to the housing 14.

The cone piece member and intermediate member are linked together by interlinking protrusions and recesses. Each of the members has a plurality of both protrusions (tabs, spines and the like) and recesses (notches, cutouts and the like). For case of simplicity and discussion herein, the protrusions will be called “splines,” “teeth” or “tabs” and the recesses will be called “notches”.

The cone piece 60 has a plurality of spline members or teeth 62 positioned around one end edge 64. The inner annular edge 72 on the intermediate member 70 has a corresponding number of mating notches or recesses 74 with tab members 76 between them. The mating linking of the spline members and notches are shown more clearly in FIG. 4. Although this connecting relationship is shown in the Figures, it is to be understood that the spline and notch relationship can be reversed with the spline members on the intermediate member and the notches on the cone piece.

In the embodiment depicted, there are 12 spline members and 12 notches. That number is not mandatory, however, and the number of mating and interlinking spline members and notches can be larger or smaller. There can be from 2-48 sets of mating spline members and notches. There also can be a different number of splines versus notches, or vice versa. The number of each do not have to be identical.

The spline members and notches also can have any size and shape so long as the purpose of providing an assembly with limited movement between the cone piece and intermediate member is maintained.

The housing 14 and input member 16 are preferably made of a steel material, as are the cone piece 60 and intermediate member 70. It is also possible to provide the intermediate member and/or cone piece out of another material, such as thermoset plastic.

The intermediate member 70 preferably has two parallel and planar surfaces 75 and 77 (see FIG. 2). It also has a diameter considerably larger than the outermost diameter of the housing 14. The difference in diameter sizes are preferably 10% or more. For example, in one embodiment, the outer diameter of the housing 14 is about 200 mm (7.9 inches), while the outer diameter of the intermediate member 70 is about 220 mm (8.7 inches).

The additional openings 108 in the intermediate member 70 are alignment holes which can be used to accurately position the intermediate member during machining and/or assembly. These openings 108 are optional, however, and do not have to be present.

The linking of the cone piece and intermediate member together with mating structures, like the spline members and notches, allows the cone piece and intermediate member to have two degrees of friction during use, namely in the rotational and axially directions. This also allows the same two degrees of freedom to exist between the housing 14 and cone piece 60.

During use of the clutch assembly 100 when the housing 14 is rotating at input speed and the input member 16 is being moved into or out of frictional engagement, or while the input member 16 is fully engaged, and the forces and torque in the components in the clutch are substantial, the cone piece “floats” and moves axially and circumferentially. Preferably, it can have a free floating axial degree of freedom of about 0.001 inches to 0.030 inches.

This also provides a ratio of 0.00015 to 0.005 for the axial gap to the friction interface major diameter (FIMD) where the FIMD (shown as dimension “A” in FIG. 1) is about 6.46 inches. These exemplary dimensions and ratios, together with the structures of the cone piece and intermediate members and their interlinking relationship, can reduce or minimize vibrations in the assembly 10, particularly any resonance.

If the intermediate member 70 has between 2 and 48 spline members (or teeth), and the FIMD is about 6.46 inches, then the ratio of the teeth to the FIMD is between about 0.3 and 7.4.

The intermediate member 70 positions the cone piece 60 where the end 66 of the cone piece is adjacent to the housing 14. During operation and axial movement of the cone piece, it can come into contact with the housing, often causing vibrations with the intermediate member. The member 70 is linked in association with the cone member at one edge 74 (the inner annular ID edge) and is fixed to the housing (by fasteners 102). In this manner, the cone member and spline members only have two degrees of motion.

The axial gap (or lack thereof) is the distance C between the outer edge 64 of the cone piece and the inner surface 25 of the housing 14. The axial gap is produced by trapping the cone piece axially in the area between the intermediate member 70 and the inner surface 25 of the housing.

FIG. 2 illustrates that an angle “X” exists between the cone member 60 and the intermediate member 70. This angle X can be between 0-90 degrees.

A friction member 15 is positioned between the inner surface of the cone piece and the outer surface of the input member 16. As described above with reference to FIG. 1, the friction member can be any conventional type of friction materials, such as those in use today, and can have numerous configurations, pieces and shapes. Also, with the present invention, it is preferred that the friction material is firmly attached, such as bonding, to the cone piece 60. The cone piece thus becomes a cone-shaped solid backing member for the friction material.

The amount of the “play” or looseness in the linking relationship between the spline members and notches is about 0.14 mm (0.006 inches) to about 5.6 mm (0.220 inches). This distance is shown in FIG. 4 as “D−1” and “D−2”, which do not have to be the same. This distance can also be expressed in a rotational degree of freedom from the axial centerline of the friction clutch of between about 0.1° to 4.0°. The ratio between these degrees of freedom and the FIMD of 6.46 inches is 0.015 to 0.62.

The precise amount of freedom of movement is not fixed but will depend on the size and rigidity of the friction clutch and its components. A smaller and more limited amount of freedom, however, is presently believed to be better in reducing noise and undesirable vibration and resonance then larger amounts of freedom.

There are several alternatives in which to position and retain the outer edge 66 of the cone piece 60 in place relative to the housing. One way is with the outer edge structure as shown in FIG. 2. Here the surface 68 at the end 66 adjacent the inner surface 25 of the housing is beveled or angled to match the angle of the inner surface 25 at the point of possible contact. This acts as a stop and keeps the cone piece from moving too far in an axial direction.

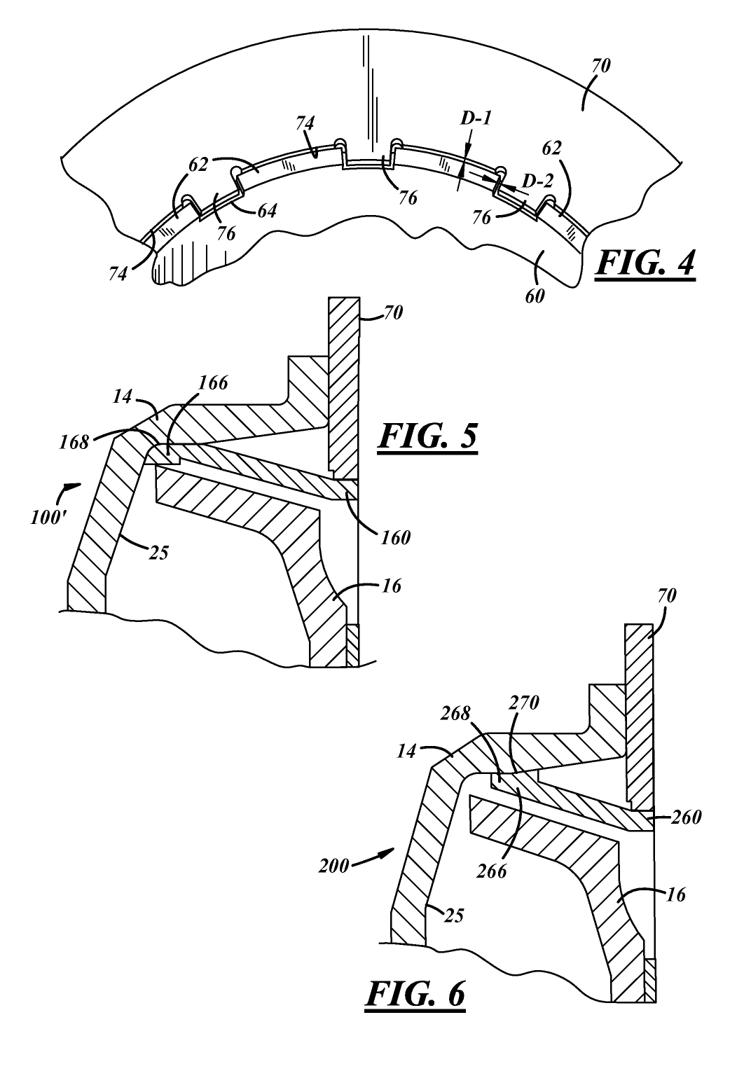

Other alternative embodiments for stopping and limiting the axial movement of the cone piece are shown in FIGS. 5, 6 and 7A-B. In FIG. 5, an enlarged downward protrusion 166 is provided on the cone piece 160 which has a surface 168 which is parallel to the inner surface 25 of the housing at that location. In FIG. 6, the outer end 266 of the cone piece 260 has an enlarged upwardly extending protrusion 268, which has an outer surface 270 which conforms to the contour of the inner surface 25 of the housing 14 where the two components come into contact.

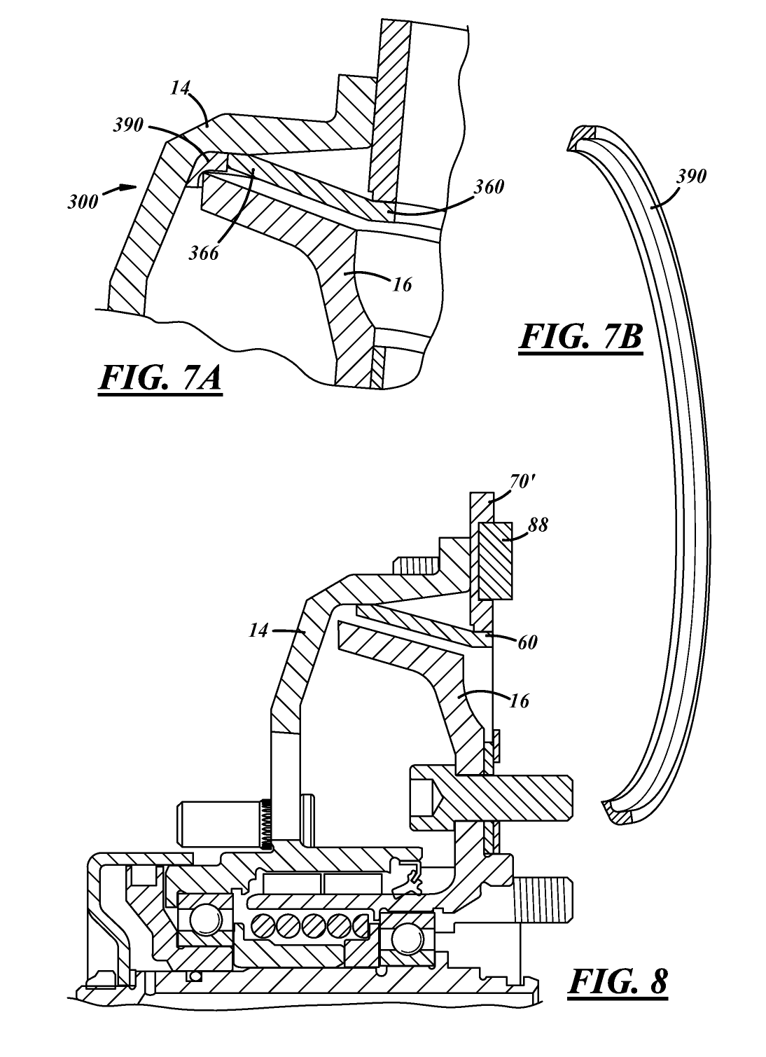

Another embodiment 300 is shown in FIG. 7A-7B. Here the outer end 366 of the cone piece 360 is substantially the same as the end 66 depicted in FIG. 2. A separate fill member 390 is provided to fill the space between the housing 14 and the end 366. The fill member 390 is shown in FIG. 7B and preferably is made of a steel or thermoset plastic material. Due to the tight clearance in the friction clutch, the fill member 390 does not have to be anchored or affixed in place, but can be loosely positioned in a “floating” type situation.

Another alternate embodiment 500 for limiting axial movement of the cone piece is shown in FIG. 11. In this embodiment, a protrusion or stop member 510 is added to, or built or formed into, the inner surface 25′ of the housing 14′. The stop member 510 limits the axial freedom of movement of the end 566 of the cone piece 560 and thus the axial movement of the cone piece 560. The stop member can be a continuous 360° ridge member provided around the inner surface of the housing, or a series of bumps or protrusions spaced around the circumference, or simply one or more pumps or protrusions.

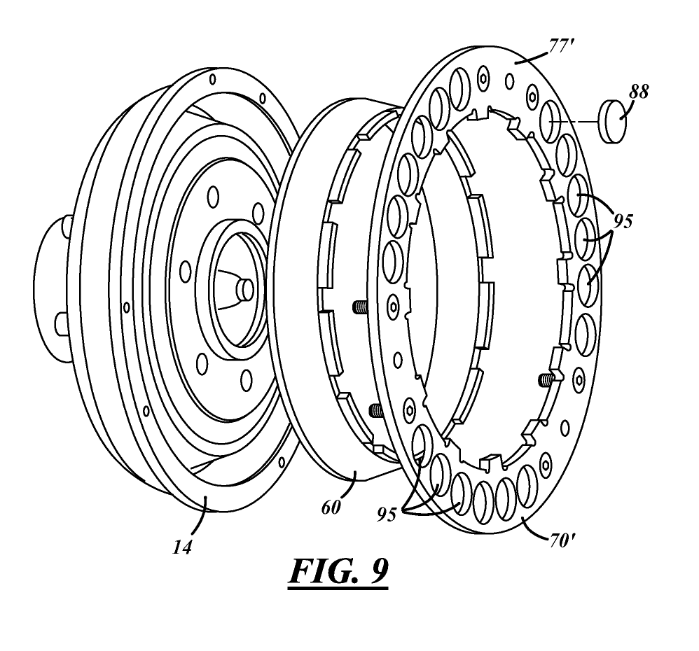

It is also possible as an alternate embodiment to use the components and structures set forth in FIG. 2-7B in a two-speed friction clutch. This is shown in FIGS. 8 and 9. The two-speed clutch combines a pneumatic high speed friction clutch with a lower speed eddy-current clutch assembly. In order to provide such an assembly, the intermediate member is machined or formed to hold a plurality of magnets.

In FIGS. 8 and 9, the intermediate member 70′ has a plurality of recesses 95 uniformly positioned on one annular surface 77′. Magnets 88 used for the eddy current embodiment are then mounted and secured in the recesses. The precise number of recesses and magnets is not critical, but depends on a number of factors, such as the size of the friction clutch, the power of the magnets, and the desired speed of rotation of the eddy-current assembly.

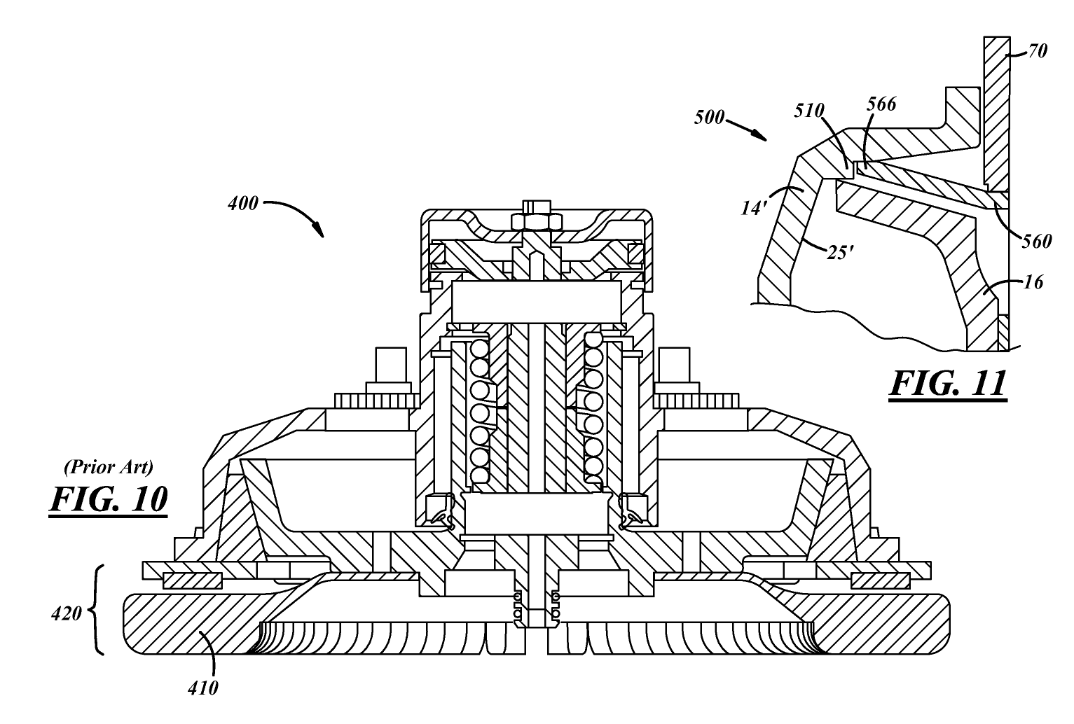

In order to complete the assembly into a two-speed clutch assembly, a flux ring needs to be attached to the opposing member which in this case is the input member. This is shown, for example, in a prior art two-speed embodiment 400 shown in FIG. 10. A flux ring 410, preferably made out of a metal material, such as steel or aluminum, is provided to complete the two-speed assembly. With the eddy-current assembly 420, the fan continues to rotate at a reduced speed when the friction clutch is not activated to rotate the fan.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A pneumatic clutch assembly for a fan drive comprising:
a rotatable clutch housing;
a fan member attached to said clutch housing and rotatable therewith;
a pulley member for attachment to a vehicle engine and for rotating at input speed;
an intermediate member attached to said clutch housing;
a cone piece member interlinked to said intermediate member by mating protrusions and recesses;
said cone piece member having a first annular surface for frictional contact;
a rotatable input member connected to said pulley member, said rotatable input member having a second annular surface for frictional contact with said first annular surface of said cone piece member;
a biased piston member operably connected to said rotatable input member in said clutch housing and being selectively actuated by pneumatic pressure to translate said input member relative to said housing;
said mating protrusions and recesses allowing two degrees of freedom of said cone piece member relative to said intermediate member.

2. The pneumatic clutch assembly as described in claim 1 wherein said two degrees of freedom are axially and circumferentially.

3. The pneumatic clutch assembly as described in claim 1 wherein said mating protrusions and recesses comprise a plurality of splines on said cone piece member and mating notches on said intermediate member.

4. The pneumatic clutch assembly as described in claim 1 wherein said mating protrusions and recesses comprise a plurality of splines on said intermediate member and mating notches on said cone piece member.

5. The pneumatic clutch assembly as described in claim 1 wherein said intermediate member comprises an annular piece of material with substantially planar and parallel surfaces.

6. The pneumatic clutch assembly as described in claim 5 wherein said material is steel.

7. The pneumatic clutch assembly as described in claim 5 wherein said material is thermoset plastic.

8. The pneumatic clutch assembly as described in claim 1 wherein said cone piece member includes a first edge which interlinks with said intermediate member and a second edge which when moved axially can come into contact with an inside surface of said clutch housing.

9. The pneumatic clutch assembly as described in claim 8 wherein said second edge has a protrusion thereon.

10. The pneumatic clutch assembly as described in claim 8 further comprising a fill member in said housing, said fill member positioned to contact said second edge of said cone piece.

11. The pneumatic clutch assembly as described in claim 1 wherein said intermediate member has an annular shape with first and second substantially planar and parallel surfaces thereon, and further comprising a plurality of magnet recesses therein.

12. The pneumatic clutch assembly as described in claim 11 further comprising a plurality of magnets positioned in said magnet recesses.

13. The pneumatic clutch assembly as described in claim 11 further comprising a flux ring member attached to said clutch assembly, wherein on eddy-current clutch.

14. The pneumatic clutch assembly as described in claim 1 further comprising a plurality of magnet members and a flux ring, said magnet members attached to said intermediate member and said flux ring attached to said clutch assembly.

15. The pneumatic clutch assembly as described in claim 1 further comprising an eddy-current assembly, said eddy-current assembly comprising at least one magnet attached to said intermediate member and a metallic flux ring member.

16. The pneumatic clutch assembly as described in claim 8 wherein said inside surface of said clutch housing has at least one protrusion positioned to contact said second edge of said zone piece, wherein axial movement of said cone piece is restricted.

17. The pneumatic clutch assembly as described in claim 16 wherein said protrusion extends circumferentially around said inside surface of said clutch housing.

18. The pneumatic clutch assembly as described in claim 16 wherein said protrusion comprises a plurality of protrusions positioned around said inside surface of said clutch housing.

19. The pneumatic clutch assembly as described in claim 3 further comprising circumferential gaps between said mating protrusions and recesses; said circumferential gaps being between about 0.006 to 0.220 inches.

20. The pneumatic clutch assembly as described in claim 3 further comprising circumferential gaps between said mating protrusions and recesses, and the rotational degree of freedom of said circumferential gaps from the axial centerline of the friction clutch is about 0.1 to 4.0 degrees.

21. The pneumatic clutch assembly as described in claim 20 wherein the ratio between the rotational degree of freedom and the FIMD is about 0.015 to 0.62.

22. The pneumatic clutch assembly as described in claim 4 further comprising circumferential gaps between said mating protrusions and recesses; said circumferential gaps being between about 0.006 to 0.220 inches.

23. The pneumatic clutch assembly as described in claim 4 further comprising circumferential gaps between said mating protrusions and recesses, and the rotational degree of freedom of said circumferential gaps from the axial centerline of the friction clutch is about 0.1 to 4.0 degrees.

24. The pneumatic clutch assembly as described in claim 23 wherein the ratio between the rotational degree of freedom and the FIMD is about 0.015 to 0.62.

25. The pneumatic clutch assembly as described in claim 8, wherein said cone piece member has an axial range of movement creating an axial gap between said second edge and said inside surface of said clutch housing.

26. The pneumatic clutch assembly as described in claim 25 wherein said axial gap is about 0.001 to 0.030 inches.

27. The pneumatic clutch assembly as described in claim 26 wherein the ratio of the axial gap to the FIMD is about 0.00015 to 0.005.

28. The pneumatic clutch assembly as described in claim 3 wherein the number of mating splines and notches are in the range of 2 to 48.

29. The pneumatic clutch assembly as described in claim 28 wherein the ratio of the number of spline members to the FIMD is about 0.3 to 7.4.

30. The pneumatic clutch assembly as described in claim 28 wherein the number of mating splines and notches is between 6-24.

31. The pneumatic clutch assembly as described in claim 30 wherein the number of mating splines and notches is 12.

32. The pneumatic clutch assembly as described in claim 4 wherein the number of mating splines and notches are in the range of 2 to 48.

33. The pneumatic clutch assembly as described in claim 31 wherein the ratio of the number of spline members to the FIMD is about 0.3 to 7.4.

34. The pneumatic clutch assembly as described in claim 31 wherein the number of mating splines and notches is between 6-24.

35. The pneumatic clutch assembly as described in claim 34 wherein the number of mating splines and notches is 12.

36. A two-speed fan drive assembly with a pneumatic friction clutch assembly and an eddy-current clutch assembly, comprising:
a rotatable clutch housing;
a fan member attached to said clutch housing and rotatable therewith;
a pulley member for attachment to a vehicle engine and for rotating at input speed;
an intermediate member attached to said clutch housing;
a cone piece member interlinked to said intermediate member by mating protrusions and recesses;
said cone piece member having a first annular surface for frictional contact;
a rotatable input member connected to said pulley member, said rotatable input member having a second annular surface for frictional contact with said first annular surface of said cone piece member;
a biased piston member operably connected to said rotatable input member in said clutch housing and being selectively contacted by pneumatic pressure to translate said input member to said housing;
said mating protrusions and recesses allowing two degrees of freedom of said cone piece member relative to said intermediate member; and
an eddy-current clutch assembly, comprising:
a plurality of magnet members positioned on said intermediate member; and
a flux ring member attached to said pneumatic friction clutch assembly.

37. The pneumatic clutch assembly as described in claim 36 wherein said two degrees of freedom are axially and circumferentially.

38. The pneumatic clutch assembly as described in claim 36 wherein said mating protrusions and recesses comprise a plurality of splines on said cone piece member and mating notches on said intermediate member.

39. The pneumatic clutch assembly as described in claim 36 wherein said mating protrusions and recesses comprise a plurality of splines on said intermediate member and mating notches on said cone piece member.

40. The pneumatic clutch assembly as described in claim 36 wherein said cone piece member includes a first edge which interlinks with said intermediate member and a second edge which when moved axially can come into contact with an inside surface of said clutch housing.

41. The pneumatic clutch assembly as described in claim 36 wherein said second edge has a protrusion thereon.

42. The pneumatic clutch assembly as described in claim 36 further comprising a fill member in said housing, said fill member positioned to contact said second edge of said cone piece.

43. The pneumatic clutch assembly as described in claim 36 wherein said intermediate member has a plurality of recesses therein, and said plurality of magnets are positioned in said recesses.
